(19) United States
(12) Patent Application Publication
(10) Pub. No.: US 2004/0154550 A1
(43) Pub. Date: Aug. 12, 2004

(54) Methods and apparatus for a remote, noninvasive technique to detect chronic wasting disease (CWD) and similar diseases in live subjects

(76) Inventor: Gary L. McQuilkin, Plymouth, MN (US)

Correspondence Address: ALTERA LAW GROUP, LLC, 6500 CITY WEST PARKWAY, SUITE 100, MINNEAPOLIS, MN, 55344-7704, US

(21) Appl. No.: 10/753,981

(22) Filed: Jan. 8, 2004

Related U.S. Application Data
(60) Provisional application No. 60/438,644, filed on Jan. 8, 2003.

(51) Int. Cl. A01K 29/00

(52) U.S. Cl. 119/174

(57) ABSTRACT

This invention is directed to an approach for noninvasively and remotely screening live animals for chronic wasting disease (CWD) via the processing of thermal and/or visible spectrum images. The image processing takes advantage of the anatomical observation that the prions and vacuoles associated with CWD first accumulate in a region of the brainstem, called the obex, which is strategically surrounded by the nuclei of the twelve cranial nerves. Using the cranial nerves as ‘implanted’ sensors, the sensitive image processing algorithms of this invention detect physiological indications of cranial nerve degradation indicating the presence and progression of the disease.

Unlike brainstem dissection, tonsil biopsy or blood tests, this live animal test may be administered from a distance making it well suited for testing anesthetized animals, penned animals or even wild animals ranging in a field or forest habitat. As thermal camera and digital camera technologies continue to improve, the diagnostic distance is limited only by lens and resolution constraints.

While described initially for CWD diagnostics, this invention has application to other diseases which have impact on the cranial nerves. By empirically determining disease-specific and species-specific algorithm coefficients, additional applications may include additional transmissible spongiform encephalopathy (TSE) diseases such as scrapie, mad-cow disease, or Creutzfeldt-Jakob disease. This invention may also be applied to numerous other diseases which impact cranial or facial nerves such as West Nile Virus, Bell's Palsy, Horner's Syndrome, and Parkinson's disease.

### CROSS-REFERENCE TO RELATED APPLICATIONS

This application claims the benefit of U.S. Provisional Patent Application No. 60/438,644, filed Jan. 8, 2003 (McQuilkin, “METHODS AND APPARATUS FOR A REMOTE, NONINVASIVE TECHNIQUE TO DETECT CHRONIC WASTING DISEASES AND SIMILAR DISEASES IN LIVE SUBJECTS”), which is hereby incorporated herein by reference in its entirety.

### BACKGROUND

Chronic Wasting Disease (CWD) is a neurological disease affecting cervids such as deer and elk. Generally recognized characteristics include loss of weight, excessive drooling and urination, drooping ears, and holding the head in a lowered position. Once an animal has contracted CWD, classic clinical symptoms may not appear for 18 to 24 months. Some cases report the appearance of characteristics up to seven years after exposure. Once symptomatic, the severity progresses until death occurs in one to six months. The cause of CWD is an unusually shaped protein called a prion. Prions are not alive like bacteria or viruses. However, they are able to replicate by altering healthy proteins within the brain of an infected animal. The altered protein molecules form vacuoles within the brainstem such that the tissue takes on a sponge-like appearance. CWD belongs to a family of diseases known as transmissible spongiform encephalopathies (TSE) which includes mad-cow disease (cattle), scrapie (sheep and goats), and Creutzfeldt-Jakob disease (human).

Prion diseases appear to be extremely species specific. When healthy cattle, deer and elk were penned with CWD-infected elk, the cattle continued to thrive for years while repeated groups of deer and elk contracted CWD and died. To date there are no known cases of CWD in humans. To date the only known way to infect cattle with CWD is to inject infected brain tissue directly into the brains of the cattle.

The species-specific transmission of CWD from animal to animal is not yet fully understood. It is thought that the prions may pass via animal to animal contact such as may occur at feeding troughs. The prions may also be deposited in the soil of animal pens via urination and defecation. Healthy animals have acquired CWD from an infected pen even after the pen was left idle for a six month period. The prions are resistant to many standard forms of disinfectant. Solvents, antiseptics, and heat have only a minimal effect. Detergents or a bleach solution are recommended to wash surfaces and greatly reduce potential contamination.

The threat presented by CWD is multi-faceted. States having large wild deer or elk populations are concerned about the health of those populations and the impact to the state economy if hunting revenues decline due to the presence of CWD. The commercial deer and elk industries also view CWD as a direct threat to their livelihood.

Current diagnostic tests for CWD require killing the animal and removing the brain stem. Preparation and laboratory analysis then takes almost a week. Because of the limited laboratory capacity of only a few labs across the country, the turn-around time can stretch to as much as four weeks. Microscopic spongiform lesions appear in the brainstem only after clinical signs are evident in deer and elk. However, abnormal prions are present prior to the onset of clinical signs.

Currently, there are no approved, live-animal tests for CWD. Possible approaches include tonsil biopsies for mule deer and white-tailed deer, capillary immuno-electrophoresis (ICE) for elk, and the detection of abnormal TSE proteins, called prions, in the blood of infected animals.

In the tonsil biopsy tests on mule deer and white-tailed deer, the deer are captured, anesthetized and a tonsil biopsy is obtained via a laryngoscope. Antibiotics and analgesics are administered prophylactically. The sample is microscopically examined for abnormal prions via immunohistochemical staining techniques. Though potentially useful for ante-mortem testing of mule deer and perhaps white-tailed deer, it has not proven to be useful for elk.

One of the newer live-animal attempts to diagnose CWD applies a capillary immuno-electrophoresis (ICE) techniques. A research group in France has reported promising results for elk. In addition, a laboratory assay has reportedly detected the presence of abnormal TSE proteins, called prions in blood from sheep with scrapie and elk with CWD. Attempts are also being made to use disease-specific physiological or metabolic markers to indicate CWD. These are secondary substances produced as a result of infection.

The search for a live-animal diagnosis for CWD has been largely directed toward microscopic analysis of tissue or chemical assay of blood. Even if found to work, these approaches are impractical and expensive for regular testing of a large numbers of animals. Tonsil biopsy is very labor-intensive since each animal must be captured, anesthetized, and include the administration of antibiotics and analgesics. Blood tests also require capture and restraint of each animal in addition to the lab analysis of the blood sample. The manpower and time required to regularly administer the tests will have a significant impact on the cost of the operation. These methods are only marginally acceptable for captive elk and deer herds where the animals tolerate the presence of humans. However, when dealing with large wild populations the need to individually capture the animals is prohibitively expensive with the potential for injury for both animal and manager.

### SUMMARY OF THE INVENTION

There is a need for a diagnostic device that tests a live subject for CWD. Additionally, it is advantageous that the diagnostic device provides a rapid diagnosis in order to permit the necessary action to minimize contact and potential transmission of the disease to nearby health subjects. It is a further advantage if the device is noncontact, noninvasive and/or capable of remote disease detection. Such a diagnostic device enables testing of individual subjects or large numbers of subjects from a convenient distance. While the present invention is described as it applies to CWD, at least the following additional diseases, with cranial nerve involvement, would benefit from the described diagnostic device: Mad-Cow Disease, Creutzfeldt-Jakob Disease, Scrapie, West Nile Virus, Parkinson's Disease, Horner's Syndrome, Bell's Palsy, and variants of these diseases.

The present invention employs thermal imaging or visible spectrum imaging in conjunction with image processing to detect and quantify subtle physiological characteristics present in live animals infected with chronic wasting disease (CWD). These characteristics are quantified via empirically derived formulas for each individual characteristic as well as a weighted combination of characteristics. The combination output may be used to indicate the probability that the animal is infected with CWD. Individual characteristics may be regularly monitored for research purposes to better understand the progression of the disease.

The advantages of this invention include:

A Live Animal Test

This test may be conducted on live animals, avoiding the unnecessary death of healthy animals. In endemic regions of the country, CWD infects only 4-6% of the wild deer and elk. Using brainstem analysis techniques, 94-96% of the animals killed are found to be healthy. In commercial herds, similar statistics yield a staggering and unnecessary economic hardship on breeders.

A Noninvasive Test

The test of this invention is noninvasive. The animals need not undergo the stress of capture, restraint and invasive procedure. The potential for animal injury is greatly reduced or eliminated. Economic advantages are derived from the noninvasive nature of this test since it requires less time to acquire the data and fewer personnel to capture and restrain the animals.

A Remote Test

The test of this invention may be conducted remotely. This feature further expands the advantages of a noninvasive test. For captive herds, acquisition equipment may be set up near a feed trough or a passage way to obtain data from a distance of 10-15 feet. With long lenses, animals in a field may be tested at a distance of 100 feet. Built into a rifle scope, this invention may be used by wildlife managers to instantly identify those animals that are infected, permitting culling of only those animals that are diseased. In a more expensive implementation, high magnification, thermal imaging equipment might be employed to survey and diagnose wild herds from aircraft.

A Rapid Test Result

The test of this invention may be analyzed very rapidly. With sufficient computing power or digital signal processing (DSP) capability, the results of this test may be obtained essentially instantaneously. Instantaneous test results, displayed on the imaging display, permits real-time selection or culling of animals based upon the diagnosis. In a lower cost or smaller size implementation, the images may be acquired and later analyzed via personal computer (PC) software. In another implementation, the analysis may be obtained via submission of the images over the internet. In yet another implementation, the analysis may be obtained by delivery of the data images to a diagnostic service company. Whether the results are available instantaneously or in a few hours, this invention dramatically improves upon the one to four week turnaround currently experienced for brainstem lab analysis.

### DESCRIPTION OF THE INVENTION

This invention is based upon empirical thermal imaging data, visible spectrum data and a preliminary understanding of the pathology of CWD, a disease which impacts the brainstem of infected animals. While further research in the field of CWD and neurological function will invariably improve the understanding of the disease, it is to be understood that the general concepts and implementations of the present invention will apply even as the underlying neurological functions are better defined.

Imaging Data

Numerous characteristics of animals infected with CWD may be identified via thermal and/or visible spectrum images of the suspect animal. Table 1 details a list of these characteristics and whether they are readily detected from thermal or visible spectrum images. The table lists the particular characteristic, the cranial nerve associated with that characteristic, provides a short description of the cause of that characteristic. In the final two columns, the table lists with an “X” whether the particular characteristic is detectable using thermal image processing or visible spectrum image processing.

TABLE 2-1
Characteristics of CWD with Associated Detection Method,
Cranial Nerves and Comments.

| | | | | DETECTION | |
|---|---|---|---|---|---|
| | | | | METHOD | |
| | | | | | VISIBLE |
| | | | | THERMAL | SPECTRUM |
| | CWD | CRANIAL | | IMAGE | IMAGE |
| | CHARACTERISTIC | NERVE | COMMENTS | PROCESSING | PROCESSING |
| 1 | Ear droop | VII | paralysis of facial | X | X |
| | | facial | nerve | measure droop | measure |
| | | | | angle | droop angle |
| 2 | Head tilt | VIII | paralysis of inner ear | X | X |
| | | vestibulocochlear | | measure tilt | measure tilt |
| | | | | angle | angle |
| 3 | Facial palsy | VII | paralysis of facial | X | X |
| | | facial | nerve | (see 4,5) | |
| 4 | general elevated | VII | thermal elevation via | X | |
| | temperatures of face, | facial | blood pooling due to | maximum & | |
| | puffy face | | inefficient venous | histogram | |
| | | | return caused by | | |
| | | | palsy of facial | | |
| | | | muscles | | |
| 5 | specific vasodilation of | VII | lack of sympathetic | X | |
| | sclera, conjunctiva, nose | facial | stimulation to smooth | maximum & | |
| | & inside ears | | muscles in arterioles | histogram | |
| | | | due to CN VII palsy | | |
| | | | (similar to Horner's | | |
| | | | Syndrome) | | |
| 6 | vasodilation of mucous | IX | lack of sympathetic | X | |
| | layer of sinuses | glossopharyngeal | stimulation to arteriole | presence of | |
| | | nerve | smooth muscles in | ‘hot spots’ over | |
| | | | mucous membrane | sinuses | |
| | | | due to CN IX palsy | | |
| 7 | hair on top of head | VII | paralysis of forehead | X | X |
| | standing on end | facial | & scalp muscles | thermal | edge detection |
| | (“fuzzy top”) | | | contrast with | between ears |
| | | | | face | |
| 8 | hypersensitivity to loud | VII | paralysis of CN VII | X | X |
| | noises | facial | which innervates | in conjunction | in conjunction |
| | | | stapedius muscle | with noise | with noise |
| | | | which dampens | source | source |
| | | | response of stapes to | | |
| | | | loud noises | | |
| 9 | loss of naso-labial | VII | paralysis of facial | X | X |
| | furrow | facial | nerve | | |
| 10 | drooping eyelids, | VII | difficulty closing eyes | X | X |
| | conjunctivitis, scleritis | facial | causes conjunctivitis, | inflammation of | measure |
| | | | and | sclera elevates | opening |
| | | | inflammation of sclera | temperature of | |
| | | | | eye region, | |
| | | | | conjunctivitis | |
| | | | | elevates | |
| | | | | temperature of | |
| | | | | eyelids | |
| 11 | drooping lower jaw, | VII | paralysis of | X | X |
| | sagging cheeks, | facial | jaw & mouth muscles | | |
| | unsymmetrical position | | | | |
| | of mouth | | | | |
| 12 | drooling | facial VII, | inability to swallow, | X | X |
| | | glossopharyngeal | paralysis of jaw & | | |
| | | IX, | mouth muscles | | |
| | | vagus X | | | |
| 13 | excessive teeth grinding | VII | attempting to | microphone | |
| | | facial | overcome partial jaw | detection | |
| | | | paralysis | (very loud) | |
| 14 | tongue hanging out or | VII | paralysis of tongue | X | X |
| | unsymmetrical tongue | facial | muscle | | |
| | position | | | | |
| 15 | loss of balance, | VIII | paralysis of inner ear | X | X |
| | abnormal gait | vestibulocochlear | | | |
| 16 | excessive weight loss | VII | inability to swallow | X | X |
| | (wasting) | facial, | causes dehydration | | |
| | | glossopharyngeal | and starvation | | |
| | | IX, | | | |
| | | and vagus X | | | |
| 17 | shoulder droop | VIII | loss of balance | X | X |
| | | vestibulocochlear | | profile | profile |
| 18 | increase in respiration | vagus X | loss of | X | |
| | rate | | parasympathetic | thermal video | |
| | | | stimulation to | camera | |
| | | | respiratory system | focused on | |
| | | | | nostrils with | |
| | | | | sampling rate | |
| | | | | of 30 Hz | |
| 19 | increase in heart rate | vagus X | loss of | X | |
| | | | parasympathetic | thermal video | |
| | | | stimulation to the | camera | |
| | | | heart | focused on | |
| | | | | artery (i.e., | |
| | | | | carotid) with | |
| | | | | sampling rate | |
| | | | | of 30 Hz | |

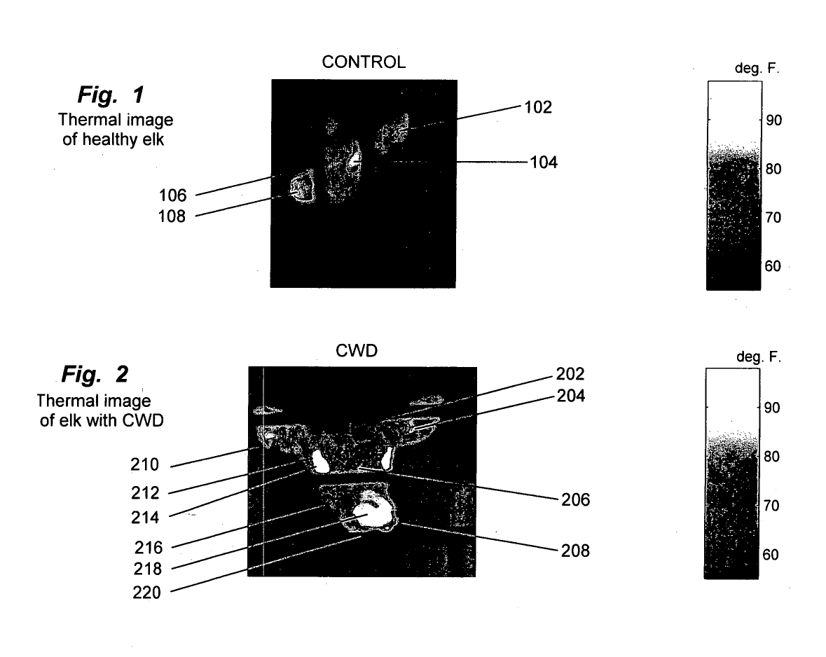

A comparison of thermal images in FIG. 1 and FIG. 2 illustrates many of these characteristics. FIG. 1 and FIG. 2 show a thermal image of a healthy elk and an elk displaying clinical characteristics of CWD, respectively. One dominant characteristic of the CWD elk is a generally elevated head temperature with specific hot spots evident in the inner region of the external ear (204), the eyelids (212) and the nose (218). The eye temperature (214), indicative of core temperature, is elevated 2-4 degrees Fahrenheit for the CWD subject. The thermal image of the eye region indicates inflammation of the eyelids (212) as well. Another dominant CWD characteristic is the drooping of the ears (210). A rotation and flaring of the ears (204) is also evident in the CWD subject. While perhaps more evident in a visible spectrum image, the ‘fuzzy’ or raised hair (202) on top of the head is typical of CWD subjects. In the region of the upper and lower sinuses (206) of the CWD elk, localized hot spots are evident. A loss of the naso-labial furrow is also present. Facial palsy (216) is observed as a puffy, rounded appearance in the CWD subject. The diseased mouth region is characterized by a dropped jaw (220), sagging cheeks (208), and, in later stages, a protruding tongue. Many CWD elk exhibit a head tilt as well. The inability to hold the head and shoulders erect is also a typical characteristic of CWD. With the addition of acoustic data, excessive grinding of the teeth is likely to be present. Using an audio source, the overreaction to a loud noise may be observed.

Anatomical Proximity of Prion Concentration in the Obex and Cranial Nerve Nuclei

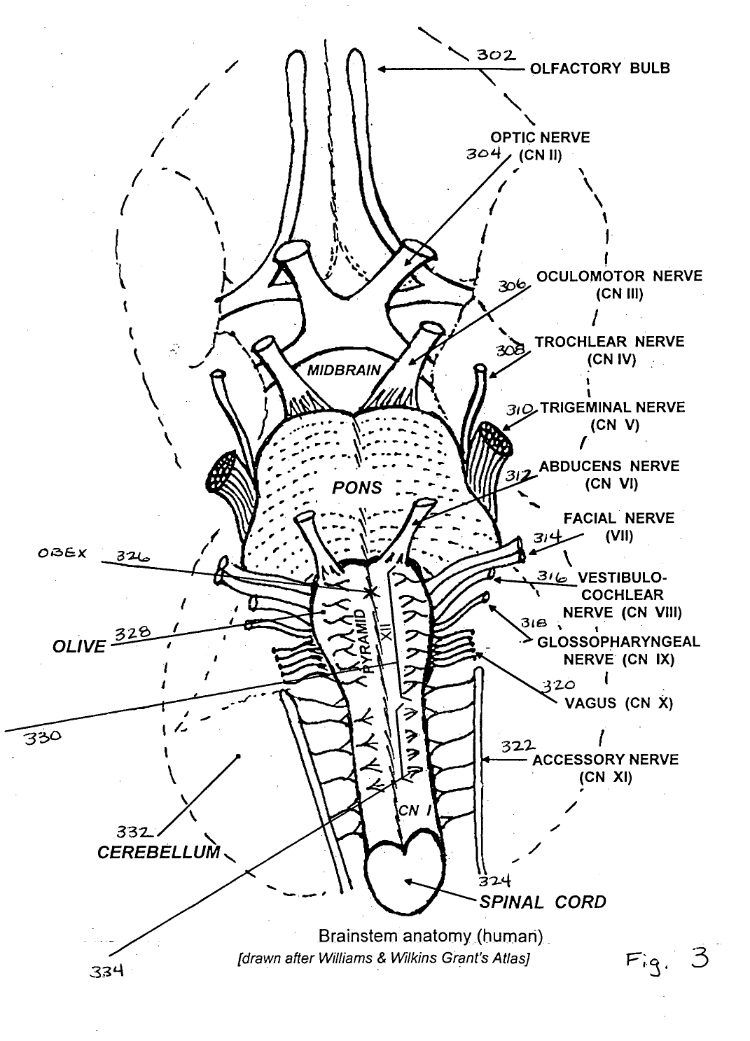

The definitive test for CWD microscopically examines a cross-section of the medulla oblongata of the brainstem at the level of the obex (326). In CWD subjects the presence of prions, abnormal protein molecules, causes many microscopic vacuoles. As seen in FIG. 3, this region of the brainstem is also the region containing the nuclei of many of the cranial nerves (334, 304, 306, 308, 310, 312, 314, 316, 318, 320, 322, 330). For this reason, it is consistent to see evidence of cranial nerve impairment as chronic wasting disease progresses.

The Use of Cranial Nerves as Sensitive, ‘Implanted’ Sensors

From a biological perspective, parts of this invention might be viewed as simply a means of accurately identifying the presence of clinical CWD characteristics. However, from an engineering and anatomical perspective, the positional relationship of the CWD vacuoles in the medulla oblongata and the location of the numerous cranial nerve nuclei provide a system design where the cranial nerves surround the region of interest in the obex, serving as sensitive, ‘implanted’ sensors. These implanted sensors create predictable outputs such as ear positions and thermal patterns as brainstem degeneration progresses. With the proper equipment and understanding, these proportional outputs can be observed and analyzed from a great distance.

Specific Characteristics of CWD and Their Cranial Nerve Connections

Many characteristics of CWD may be explained by cranial nerve degeneration. Such degeneration follows logically from the presence of prions and vacuoles within the cranial nerve nuclei.

Based upon brainstem anatomy and the characteristics exhibited by CWD subjects, the anatomical position for the nuclei of cranial nerve (CN) VII (314) may be closest to the region of the brainstem affected by the CWD vacuoles and prions. The sensitivity of CN VII (314) to the presence of CWD vacuoles may also be due, in part, to the winding path of the facial nerve (314) within the pons. This lengthy path exposes a greater length of the facial nerve to a higher concentration of prions and vacuoles. Paralysis of the facial nerve (314) (CN VII), exhibits the following characteristics present in CWD victims:

a) ear droop (210) due to paralysis of the auricular muscle;

b) facial palsy (216);

c) specific vasodilation of sclera (214), conjunctiva (212), nose and inside external ears (204) due to the lack of sympathetic stimulation of smooth muscle in the arterioles similar to Horner's Syndrome;

d) general elevated temperatures of the face caused by venous pooling in the absence of facial muscle tone;

e) ‘fluffy’ scalp hair (202) due to flaccid scalp and forehead muscles;

f) hypersensitivity to loud noises due to paralysis of the stapedius muscle which dampens the stapes bone when excessive vibration occur;

g) loss of naso-labial furrow with flaccid facial muscles;

h) drooping of the jaw (220) and cheeks (216) due to flaccid facial muscles;

i) loss of tongue control due to facial muscle paralysis; and

j) excessive weight loss due to the starvation and dehydration consistent with the inability to swallow.

Anatomically, the vestibulo-cochlear nerve (316), CN VIII, is adjacent to the facial nerve (314) (VII). Given this anatomy, it is not surprising that coordination and positional characteristics, attributable to a compromised vestibular system (CN VIII), are present with CWD such as:

a) head tilt; and

b) loss of balance or abnormal gait.

The glossopharyngeal nerve (318) (CN IX) is also in close proximity to the facial nerve (314) (VII) and the vestibulo-cochlear (316) (VIII) nerve. With regard to CWD characteristics, CN IX (318) is involved with the gag reflex, the ability to swallow and sympathetic innervation of arteriole smooth muscles in the lining of the mucous membranes within the sinuses (206).

The vagus nerve (320) (X) is the most innervated of the cranial nerves. Its nuclei are in close proximity to VII (314), VIII (316) and IX (318). The vagus nerve (320), among other functions, is responsible for slowing heart rate, reducing arterial pressure, and facilitating digestion and absorption of nutrients. When the vagus (320) (X) function is compromised at its nuclei via CWD vacuoles, the expected results would include an increase in heart rate, an increase in arterial pressure, and a reduction in digestion and the absorption of nutrients. These responses are consistent with the following CWD characteristics:

a) hyperactivity due to an increase in heart rate and arterial pressure; and

b) wasting due to an inability to digest and absorb nutrients.

The other two cranial nerves having nuclei in close proximity to VII (314), VIII (316), IX (318), and X (320) are cranial nerves VI (312) and XII (330). The abducens nerve (312) (VI) controls eyeball movement and the hypoglossal nerve (330) (XII) controls the tongue. While loss of eyeball control has not yet been commonly documented as a CWD characteristic, the loss of tongue control is consistent with observed CWD progression.

Early Detection and Objective Measurement of Cranial Nerve Function via Thermal Imaging and Image Processing Techniques

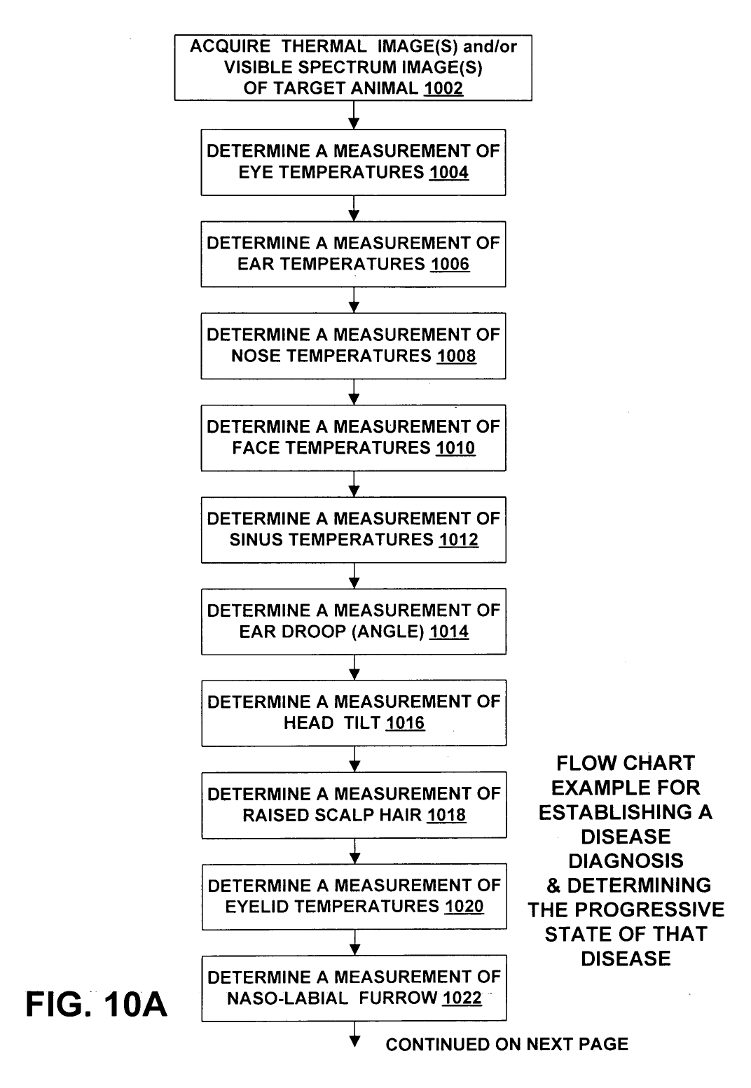

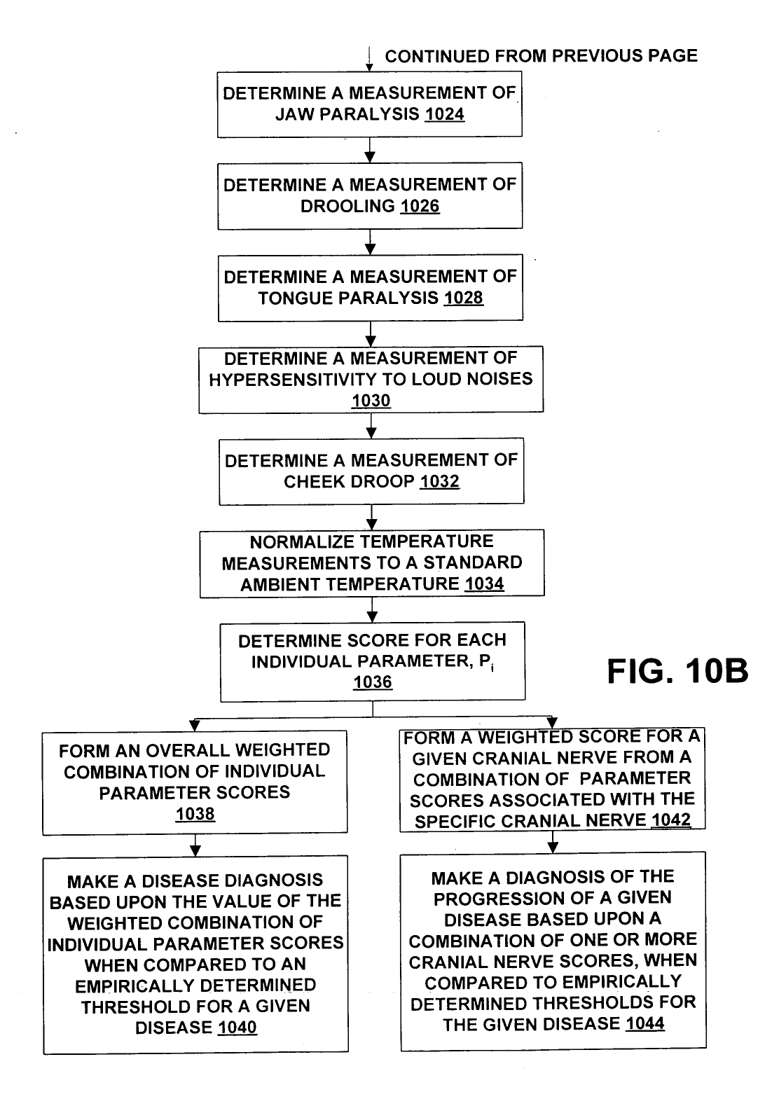

The noninvasive and remote measurement of each individual characteristic of cranial nerve dysfunction with CWD provides a sensitive, quantitative indication of disease presence and progression. FIGS. 10A and 10B show a flow chart example for establishing a disease diagnosis and determining the progressive state of that disease.

Elevated Eye Temperatures.

The elevation of eye temperatures has been observed to be a characteristic of CWD. Eye surface temperature is typically a good indicator of core temperature since the vitreous humor of the eye is a watery fluid, of sufficient volume, which is near core temperature due to its close proximity to the brain. The eye's surface temperature may also be elevated due to inflammation of the sclera (214). This inflammation may be attributed to the lack of sympathetic, smooth muscle stimulation in specific arterioles due to CN VII (314) palsy (similar to Horner's Syndrome).

In a thermal image of a the head of a suspected CWD animal, the maximum temperature is the surface temperature of the eye (214). Therefore,

T_{eye}=max(I₁) (2-1)

where T_{eye} is the temperature of the eye surface (1004); and II is the matrix of temperatures making up the thermal image of the subject with each matrix element corresponding to a pixel temperature within the thermal image. Alternatively,

T_{eye}=mean (I_{eye}) (2-2)

where I_{eye} is the region of the thermal image corresponding specifically to the eye surface; and T_{eye} is the mean temperature of I_{eye} (1004). (Other statistical functions, such as maximum, minimum, or median, may be substituted for the ‘mean’ function.)

Vasodilation of Nose and Ears.

The temperature elevation of the nose (218) and the inner portion of the external ear (204) temperatures has been observed to be characteristic of CWD. This elevation is likely due to the lack of sympathetic, smooth muscle stimulation in specific arterioles caused-by palsy of the facial nerve (314), CN VII (somewhat similar to Horner's Syndrome). Lacking normal vasoconstrictive stimulation, the vessels dilate. From a thermal image it is possible to find an average temperature (or other statistical choice such as maximum, minimum, median, etc.) of the pixels within designated regions. The regions of the inner external ears (204) and the nose (218) may be selected manually or by automated image processing means such that:

Tₑₐᵣ=mean (Iₑₐᵣ); and (2-3)

Tₙₒₛₑ=mean (Iₙₒₛₑ) (2-4)

where Iₑₐᵣ is the region of the thermal image corresponding to the inner part of the external ear (204); Tₑₐᵣ is the mean temperature of Iₑₐᵣ (1006); Iₙₒₛₑ is the region of the thermal image corresponding to the nose (218); Tₙₒₛₑ is the mean temperature of Iₙₒₛₑ (1008).

General Temperature Elevation of the Face

The general temperature elevation of the face has been observed to be characteristic of CWD. This general elevation is likely due to blood pooling as a result of inefficient venous return caused by flaccid facial muscles which is likely a result of a degeneration of cranial nerve VII. A volume of fluid in the facial region provides a lower thermal resistance, thus resulting in greater heat loss in this region and an elevated skin temperature as observed. The regions of the face (216, 206), excluding ears (204), eyes (212, 214), nose (218) and scalp (202) may be selected in a thermal image manually or by automated image processing means such that:

T_{face}=mean (I_{face}) (2-5)

where I_{face} is the region of the thermal image corresponding to the face, excluding ears, eyes, nose and scalp; and T_{face} is the mean temperature of I_{face} (1010)

Vasodilation of Arterioles in Mucous Membranes of Upper and Lower Sinuses

Thermally, the upper and lower nasal regions (206) of the face have shown localized hot spots in CWD animals. These localized temperature elevations may be due to vasodilation of the arterioles of the underlying sinus membranes. The glossopharyngeal nerve (318), CN IX, is involved with the sympathetic vasoconstriction of arterioles in the lining of the mucous membranes of the sinuses.

Thus, a degeneration of CN IX (318) due to CWD would contribute to vasodilation of arterioles in the sinuses (206). This in turn may cause the irregular shape of the sinus cavities to appear on the surface as irregular thermal patterns (206). Letting Iₛᵢₙᵤₛₑₛ be the region of the thermal image corresponding to the facial area over the upper and lower sinuses (206), a measure of ‘hot spot’ presence may be made via:

Sₛᵢₙᵤₛ=std(Iₛᵢₙᵤₛ) (2-6)

where Iₛᵢₙᵤₛ is the region of the thermal image over the upper and lower sinuses (206) selected either manually or via automated image processing means; and Sₛᵢₙᵤₛ is the standard deviation of the temperatures within Iₛᵢₙᵤₛ (1012). For healthy subjects the temperatures over the sinuses will be relatively constant (106). However, for CWD subjects the localized hot spots will result in an increase in the standard deviation as computed in equation (2-6).

Ear Droop

Ear droop (210) has been observed to be a characteristic of CWD. This characteristic is likely caused by the loss of auricular muscle function due to degraded function of the facial nerve (314) (CN VII).

This invention provides for the measurement of the ear droop (210) via image processing methods from either a thermal or visible spectrum image of the test animal. To measure ear droop (210) it is first necessary to measure the ear angle of the test animal with respect to a fixed coordinate, such as vertical. This may be computed from image coordinates as follows:

$${θ}_{ear} = {tan}^{- 1} [ \frac{\vert {x}_{tip} - {x}_{base} \vert}{\vert {y}_{tip} - {y}_{base} \vert} ] \qquad ( 2 \text{-} 7 )$$

where θₑₐᵣ is the angle of the ear with respect to vertical; [xₜᵢₚ, yₜᵢₚ] is the position of the tip of the ear with x being the horizontal positional component and y being the vertical positional component; and [X_{base}, Y_{base}] is the position of the base of the ear. The measured ear angle is then compared to the ear angle of a healthy reference animal, θ_{ref}.

The reference ear angle, θ_{ref}, is determined empirically from samples of healthy animals. With a measured ear angle and a reference ear angle the ear droop angle may be easily computed:

θ_{droop}=θ_{ref}−θₑₐᵣ (2-8)

where θ_{droop} is the ear droop angle (1014); θ_{ref} is the reference ear angle for healthy animals; and θₑₐᵣ is the measured ear angle for the test animal.

It is common in CWD animal that ear angles will differ for left and right ears. This might be due to different levels of facial nerve paralysis for opposite sides, or it may be due to a head tilt. Head tilt, also a characteristic of CWD, may be removed from the ear droop measurement as follows:

θ_{corrected ear}=θₑₐᵣ−θ_{head tilt} (2-9)

where θ_{corrected ear} is the angle of the ear with respect to vertical corrected for head tilt (see the next section for the measurement of head tilt); and θ_{head tilt} is the angle of the head tilted to one side or the other. The sign of head tilt angle in equation (2-9) may be considered as follows:

right ear angle: head tilted toward right side—θhead tilt is positive

right ear angle: head tilted away from right side—θ_{head tilt} is negative

left ear angle: head tilted toward left side—θ_{head tilt} is positive

left ear angle: head tilted away from left side—θθ_{head tilt} is negative

In other words, if the head is tilted toward one side, the ear angle measurement on that side will be too large and must be reduced by the head tilt angle. Likewise, if the head is tilted away from a given side, the ear angle measurement on that side will be too small and must be increased by the head tilt angle.

It should be noted that the measurements for ear angles and head tilt assume the use of a level camera to acquire the images used to compute the angles. In the event that the camera is not level, any camera tilt may be accounted for in the ear and head tilt measurements.

Some variations on ear angle measurements present themselves for empirical evaluation. Average, ear angle measurements cancel head tilt and camera tilt from consideration,

θ_{avg ear} =(θ_{R}_{_{—}}^{ear}+θ_{L}_{_{—}}ₑₐᵣ); (2-10)

where θ_{R}_{_{—}}ₑₐᵣ is the ear droop angle for the animal's right ear; θ_{L}_{_{—}}ₑₐᵣ is the ear droop angle for the animal's left ear; and θ_{avg} is the average of right and left ear angles. Additionally, taking the maximum of right and left ear angles is physiologically significant since facial nerve paralysis that is more severe on one side than the other would cause one ear to droop more and also cause the head to tilt in that direction. Such a formula is:

θₘₐₓ=max([θ_{R}_{_{—}}ₑₐᵣ, θ_{L}_{_{—}}ₑₐᵣ]) (2-11)

where θₘₐₓ is the maximum of the right ear angle, θ_{R}_{_{—ear}}, and the left ear angle, θ_{L}_{_{—}}ₑₐᵣ.

Head Tilt

Head tilt has been observed to be a characteristic of CWD. This characteristic is likely caused by the loss of balance or positional function caused by the degradation of the vestibulo-cochlear nerve, CN VIII (316).

This invention provides for the measurement of head tilt via image processing methods from either a thermal or visible spectrum image of the test animal. To measure head tilt it is first necessary to measure the head position with respect to orthogonal coordinates such as horizontal or vertical. Since the eyes (214) are the primary feature available for head tilt calculations, horizontal makes a good reference coordinate. Head tilt, θ_{head tilt} (1016), may be computed as follows:

$${θ}_{head tilt} = {tan}^{- 1} [ \frac{{d}_{elevation}}{{d}_{separation}} ] ; \qquad ( 2 \text{-} 12 )$$

where θ_{head tilt} is the absolute value of the head tilt angle; dₛₑₚₐᵣₐₜᵢₒₙ is the horizontal separation of the eyes, center-to-center, in image units (distance or pixels); and dₑₗₑᵥₐₜᵢₒₙ is the difference in eye elevation in the vertical plane in image units. The direction of tilt may be noted as, “to the left”, “to the right”, or a sign convention assigned for convenience. (Sign conventions incorporating positive and negative head tilt angles must examine the effect on ear droop angles for consistency.)

Ear/Head Coordinates

While the acquisition of ear angles and head tilt angles with a leveled camera (as described in the previous sections) is computationally preferred, a useful measurement can be made with images obtained from unleveled or unknown camera orientations. A line joining the center of the two eyes may be used as a relative ‘horizontal’ axis. A relative ‘vertical’ axis may be found perpendicular to the eye-to-eye axis. The calculation of ear angles may be computed as discussed previously except that head and ears must be rotated by the angle between the eye-to-eye axis and the actual x-axis of the image. Ear angles, computed with reference to the relative axis may still fall into the ‘drooping’ classification. Additionally, non-symmetrical right and left ear droops are an indication of facial nerve degradation.

This relative coordinate system established by the eye-to-eye orientation is well suited for lower-cost, visible spectrum, digital cameras. Such cameras have commercially available telephoto lenses and even zoom telephoto lenses. Adaptability to rifle scopes provides additional application potential. Care should be taken to correct any image analysis for pin cushion and barrel distortion due to the lens selection prior to calculation of angles.

Elevated Temperatures Around the Eye

Elevated temperatures around the eyes (214), especially in the region of the upper eyelid (212), have been observed via the thermal imaging of CWD animals. A degraded facial nerve (314) (CN VII) correlates with vasodilation of the sclera (214) and conjunctiva (212). Additionally, paralysis of the orbicularis oculi muscle, innervated sympathetically by a branch of the facial nerve (314) (CN VII), makes it difficult to close the eye (214). Both of these conditions may invite swelling of the eyelids (212) which would explain the elevated temperatures above or below the eye.

T_{eyelid}=mean (I_{eyelid}) (2-13)

where I_{eyelid} is the region of the thermal image corresponding to the upper (or lower) eyelid (212) of one or both eyes; and T_{eyelid} is the mean temperature of I_{eyelid} (1020).

Erect Hair on Top of the Scalp

Erect hair on the top of the scalp (202), giving a ‘fuzzy top’ appearance, is characteristic of CWD subjects. The neurological cause of the characteristic is not directly evident. The expected method of erecting hair follicles is via sympathetic stimulation of the arrector pili muscles. When stimulated these muscles contract, placing each individual hair follicle in an erect position. However, since the arrector pili muscles have only sympathetic innervation, the removal of stimulation (as would result from CWD, cranial nerve degradation) should result in the scalp hair not standing on end. Perhaps this CWD trait is a result of paralysis of the occipitalis muscle which pulls the scalp posteriorly. The occipitalis muscle is controlled via the posterior auricular branch of the facial nerve (314) (CN VII) which is susceptible to CWD degradation. Regardless of the pathology, this characteristic may be evaluated by comparing the differential temperature between the upper scalp (202) and the forehead region. There appears to be a thermal transition in this region of the head and face.

ΔTₜₒₚ=mean (I_{forehead})−mean (I_{scalp}) (2-14)

where I_{forehead} is the region of the thermal image corresponding to the forehead of the animal below the thermal transition region; I_{scalp} is the region of the thermal image corresponding to the scalp of the animal above the thermal transition region; and ΔTₜₒₚ is the differential temperature between the two regions (taking the mean of these regions minimizes the effects of any localized deviation) (1018).

Cheek Droop and Loss of Naso-Labial Furrow

The drooping of the cheek (216) and the loss of the naso-labial furrow is characteristic of facial nerve (314) paralysis and thus a characteristic of CWD. The loss of naso-labial furrow may be detected via a three-dimensional (3D), range camera with the capability to detect the facial surface characteristics. Specifically, the loss of naso-labial furrow may be determined in 3D via the presence of a more gradual skin slope from the bridge of the nose to the cheek surface instead of the more abrupt transition for healthy animals. Cheek droop (216) may be detected via thermal image analysis (1032). Detecting the shape of the edge transition from cheek to background temperatures is important. In healthy animals, the edge of the cheek silhouette is a clean, smooth line. With cheek droop, this transition line exhibits lumps corresponding to the drooping, puffy skin contour.

A detection technique for the loss of the naso-labial furrow (1022) may include the following steps:

a) obtain a 3D surface of the nasal area;

b) select one or more surface lines, progressing from the animal's left to its right, perpendicular to a line running medially up the center of the face;

c) compute the slope of the selected line;

d) if a peak of that slope is above a predetermined threshold, then the naso-labial furrow is present;

e) conversely, if the maximum slope of the line is below the predetermined threshold, then the naso-labial furrow is absent and a trait of CWD is present.

A detection technique for the presence of drooping cheek (216) may include the following steps (1032):

a) Detect the image edge associated with the line between the animals cheek and the background in either a thermal image or a visible spectrum image;

b) fit a high-order, polynomial to the edge;

c) compare the magnitude of high and low order coefficients in the fitted polynomial; and

d) if the energy in the higher order terms is above an empirically determined threshold the cheek transition line has multiple humps due to droop and puffiness.

Jaw Paralysis

Jaw paralysis (220) is another characteristic common to CWD animals caused by palsy of the facial nerve (316) (CN VII). This particular trait is not easily detected via thermal or visible spectrum images until it progresses to the severity which makes the animal unable to close its mouth. A wide, higher temperature, horizontal line below the nose on a thermal image is an indication that the mouth is open and is a likely indication of jaw paralysis (1024).

Drooling

Drooling is another characteristic of CWD animals. It is a result of a paralysis of jaw and mouth muscles and the inability to swallow. Jaw and mouth paralysis is due to degradation of the facial nerve (314) (CR VII). The inability to swallow may be attributed to a compromise of the vagus nerve (320) (CN X) and the glossopharyngeal nerve (318) (CN IX). Drooling typically appears as a thermal ‘V’ under the chin of a subject since the saliva is a higher temperature than the background. Image processing techniques may be used to locate the nose and search for a ‘V’ formation of elevated temperature beneath it (1026).

Tongue Paralysis

Paralysis of the tongue is a characteristic of CWD. Cranial nerves VII (314) (facial), IX (318) (glossopharyngeal), XII (330) (hypoglossal), and X (320) (vagus) contribute to tongue control. The hypoglossal nerve (330), with its nucleus very near the facial nerve in the pons, is responsible for retracting the tongue. In later stages of CWD the tongue is protruded. A protruding tongue may be automatically identified via image processing techniques in either a thermal or visible spectrum image (1028). One method is to locate the nose, scale and fit one of two templates to the edge between the chin and the background where one template has no protruding tongue and the second does have a protruding tongue. The template with the highest correlation to the test case is the match.

Hypersensitivity to Loud Noises

CWD victims are hypersensitive to loud noises. This is likely a result of paralysis of the stapedius muscle which dampens excessive vibration of the stapes bone for loud noises. The facial nerve (314) (VII) stimulates the stapedius muscle. This characteristic may be evaluated by introducing a loud noise and evaluating the response within the thermal or visible spectrum image (1030).

Normalization of Ambient Temperatures

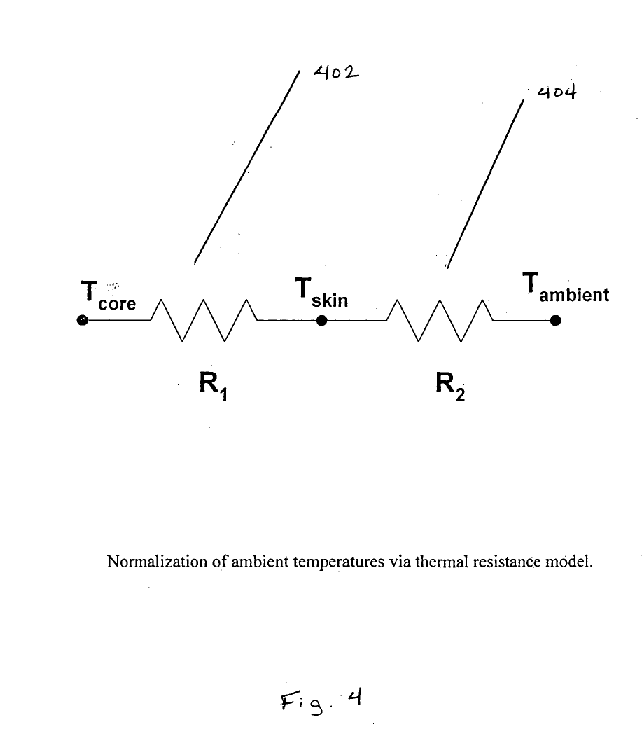

Skin temperatures are known to change with changes in ambient or air temperatures. The application of a normalization formula permits the comparison of equivalent physiological data acquired at different ambient temperatures. FIG. 4 shows a simple thermal resistance model which may be used to normalize the ambient temperatures.

In the simple thermal resistance model of FIG. 4, the core temperature of the subject is represented by T_{core}. Thermal resistance, R₁ (402), represents the thermal resistance attributable to the arteries, arterioles, skin and insulating hair between the core temperature of the body and the skin or hair surface visible to the thermal camera. The temperature of the skin (or hair), as viewed with the thermal camera, is represented by Tₛₖᵢₙ. The thermal resistance between the skin surface and the ambient air is represented by R₂ (404). T_{ambient} is the temperature of the ambient air. The variables are related by the following equation:

$${T}_{skin} = ( {T}_{core} - {T}_{ambient} ) ( \frac{{R}_{2}}{{R}_{1} + {R}_{2}} ) + {T}_{ambient} \qquad ( 2 \text{-} 15 )$$

In this model the physiological changes such as vasoconstriction and blood pooling significantly change the thermal resistance between the core temperature and the skin surface, R₁ (402).

In order to compare thermal data acquired at different ambient temperatures the ratio, K₁, is first computed as shown below:

$${K}_{1} = ( \frac{{R}_{2}}{{R}_{1} + {R}_{2}} ) \qquad ( 2 \text{-} 16 )$$

where R₁ (402) and R₂ (404) are as previously defined. Then standard ambient and core temperatures are used to compute a skin temperature adjusted for ambient variations as shown in equation (2-17) (1034):

Tₛₖᵢₙ_{_{—}}ₙₒᵣₘ=(T_{0 core}T_{0 ambient})K₁+T_{0 ambient} (2-17)

where T_{0 core} is a standard core temperature; T_{0 ambient} is a standard ambient temperature; and Tₛₖᵢₙ_{_{—}}ₙₒᵣₘ is a normalized skin temperature which may be compared to a database of empirical data; and K1 is the temperature-division ratio defined in equation (2-16). While it is advisable to apply this, or a similar normalization, to all thermal data used in this invention, such normalizations have not been shown in equations for simplification purposes.

Individual Trait Scoring

Once parameter values have been acquired via thermal and/or visible spectrum images, the analysis or scoring may be conducted in a number of ways. Examples of these methods include scoring by range and scoring by distribution.

Scoring according to range involves computing the ratio of the temperature difference between the CWD extreme and the observed temperature compared to the entire range of expected values. Such a calculation is shown below:

$${P}_{normalized} = \frac{{T}_{max} - {T}_{test}}{{T}_{max} - {T}_{min}} \qquad ( 2 \text{-} 18 )$$

where Tₘₐₓ is the maximum expected temperature for a CWD subject and Tₘᵢₙ is the minimum expected value for a healthy subject; Tₜₑₛₜ is the observed temperature for the test subject; and P_{normalized} is the normalized score.

Another way of scoring these data may be referred to as distribution scoring. This method places a normal probability density function, p₁, between the ranges of the healthy and the diseased values such as:

$${p}_{1} = ( \frac{1}{σ \sqrt{2 π}} ) {ⅇ}^{( - \frac{1}{2} ( \frac{{( x - μ )}^{2}}{{σ}^{2}} ) )} \qquad ( 2 \text{-} 19 )$$

where x is the parameter value acquired from healthy or diseased subjects; μ is the midpoint between the healthy range and the diseased range; and σ is the standard deviation of the probability density function. In this normal probability density function, the midpoint, μ, and the standard deviation, σ, are selected as shown below:

μ=median(Xₐₗₗ) (2-20)

σ=min([σ_{healthy, σ}_{cwd}]) (2-21)

where Xₐₗₗ refers to all parameter values of known healthy and diseased animals; σ_{healthy} is the standard deviation of the healthy parameter values; and σ_{cwd} is the standard deviation of the diseased parameter values. The midpoint, μ, is found most accurately if there is an even and equal number of healthy and diseased parameter values. The median value places the value of the midpoint midway between the largest parameter value of the lower group and the smallest value of the upper group. In this manner, a centrally placed density function is obtained even for overlapping ranges. Using a minimum (or mean) of the individual group standard deviations helps to scale the width of the density function to approximate the data. A scoring function may be obtained by integrating the density function, p₁, over the range of −∞ to the parameter value, X, as shown below:

$${P}_{score} = 100 {\int }_{- ∞}^{x} {p}_{1} ⅆ x \qquad ( 2 \text{-} 22 )$$

where p₁ is the probability density function defined in equation (2-19); X is the value of the given parameter; and P_{score} is the scoring value between 0 and 100 with a score of zero indicating no trace of disease and 100 providing a full indication of disease.

In discrete format, equations (2-22) becomes:

$${P}_{score} = 100 ( Δ x ) {\sum }_{- ∞}^{X} {p}_{1} \qquad ( 2 \text{-} 23 )$$

where X is the specific parameter value; p₁ is the probability density function described in equation (2-19); and Δx is the increment of x parameter values.

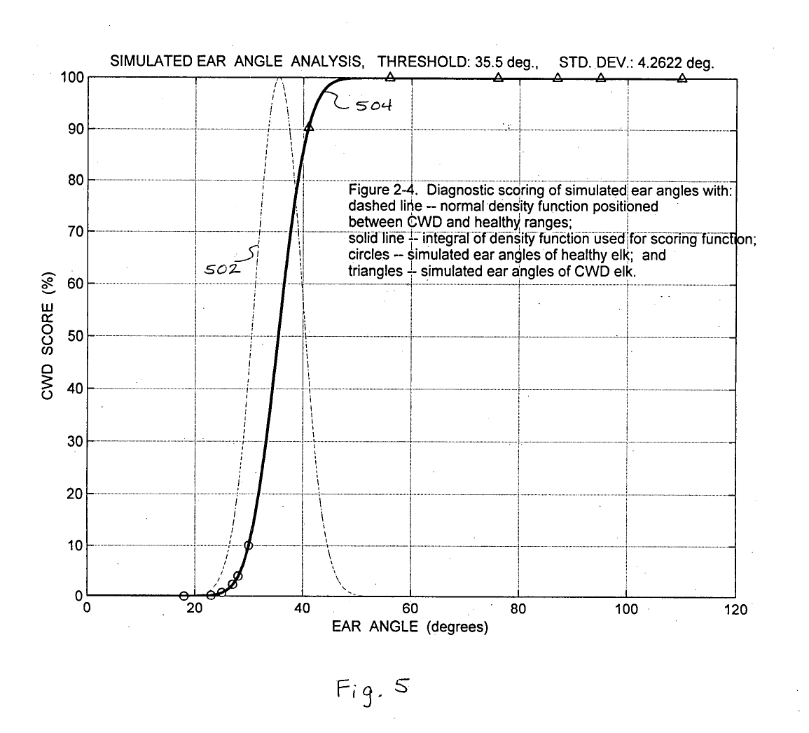

FIG. 5 illustrate the application of equations (2-19) and (2-23). In this figure simulated CWD and healthy ear angles are processed where,

θ_{CWD}=[41 87 110 76 95 56]; (2-24)

θ_{healthy}=[25 27 18 28 30 23]; (2-25)

μ=median([θ_{CWD}, θ_{healthy}])=35.50°; (2-26)

σ=min([σ_{CWD}, σ_{healthy}])=43°; (2-27)

P_{score}_{_{—}}ₑₐᵣ_{_{—}}_{CWD}=[90.4 100 100 100 100 100]; and (2-28)

P_{score}_{_{—}}ₑₐᵣ_{_{—}}_{healthy}=[0.71 2.37 0.002 4.02 10.1 0.17] . (2-29)

Integration of the probability density function (502) yields the scoring function (504) for these ear angle data. With the described algorithm, these simulated data are properly classified with the score value indicating the probability that the animal has CWD in percentage according to the specific parameter, namely, ear angle. In the above example, the diseased animals yielded scores ranging from 90.4% to 100% with a median score of 100%. The healthy animals yielded scores of 0.002% to 10.1 % with a median score of 1.54%.

Each of the individual, physiological traits impacted by CWD may be scored similar to the ear angles above (1036). Table 2-2 shows examples of the physiological traits and indicates additional information acquired during empirical evaluations of healthy and diseased animals. The table lists the trait, provides the symbol for that trait used herein, indicates whether the trait is a graduated indicator or a binary indicator, and gives a typical parameter range for that trait.

TABLE 2-2
Physiological Traits and Information
Available from Empirical Data Analysis

| | | | Graduated | Binary | Parameter |
|---|---|---|---|---|---|
| | Trait | Symbol | Indicator | Indicator | Range |
| 1 | eye temperature | T_{eye} | X | | 96°-104° F. |
| 2 | ear temperature | Tₑₐᵣ | X | | 78°-96° F. |
| 3 | nose temperature | Tₙₒₛₑ | X | | 78°-96° F. |
| 4 | face temperature | T_{face} | X | | 78°-96° F. |
| 5 | sinus temperature | Sₛᵢₙᵤₛ | X | | 1.2-2.6 |
| | variation | | | | |
| 6 | ear droop angle | θ_{droop} | X | | 0°-120° |
| 7 | head tilt angle | θ_{head tilt} | X | | 0°-45° |
| 8 | relative ear droop | θ_{droop}_{_{—}}ᵣₑₗ | X | | 0°-120° |
| | angle | | | | |
| 9 | eyelid | T_{eyelid} | X | | 96°-104° F. |
| | temperature | | | | |
| 10 | differential scalp | ΔTₜₒₚ | X | | 0°-30° F. |
| | temperature | | | | |
| 11 | Naso-Labial | m_{furrow} | | X | 0/100% |
| | Furrow | (max | | | |
| | | slope) | | | |
| 12 | cheek droop | | | X | 0/100% |
| 13 | jaw paralysis | | | X | 0/100% |
| 14 | drooling | | | X | 0/100% |
| 15 | tongue paralysis | | | X | 0/100% |
| 16 | hypersensitivity | | | X | 0/100% |
| | to loud noises | | | | |
| 17 | shoulder droop | | | X | |
| 18 | increase in | fᵣₑₛₚ | X | | 5-80 bpm |
| | respiration rate | | | | |
| 19 | increase in heart | f_{HR} | X | | 50-200 bpm |
| | rate | | | | |

Diagnosis Formulas

The diagnosis of a test animal may be determined by a combination of a number of scoring functions, one example of which is shown in equation (2-30):

Dₜₑₛₜ₌k₁P_{score1}+k₂P_{score2}+k₃+P_{score3}+. . . kₙP_{score n}; (2-30)

where P_{score i} are the scoring functions from equations (2-22) and (2-23) for each of the applicable parameters such as ear angle, head tilt or eye temperature; kᵢ are the weighting coefficients determined from empirical testing for each of the applicable parameters; and Dₜₑₛₜ is the diagnosis for the animal under test (1038, 1040).

Based on empirical data, equation (2-30) may instead take a form similar to one of the following:

Dₜₑₛₜ=median[k₁P_{score1}+k₂P_{score2}+k₃P_{score3}+. . . kₙP_{score n}]; ((2-30):

D_{test=mean[}k₁P_{score1}+k₂P_{score2}+k₃P_{score3}+. . . kₙP_{score n}]; or (2-32)

D_{test=[}k₁(P_{scorel})^{m1}+k₂(P_{score 2})^{m2}+k₃(P_{score3})^{m3}+. . . kₙ(P_{score n})^{m}^{ⁿ}]^{q}; (2-33)

where mᵢ are exponents for each scoring function and q is an exponent for the overall weighted sum.

Disease Progression Formulas

The progression of the disease may be determined by evaluating characteristics assigned to each of the cranial nerves, for example as shown below:

D_{VII=mean[}k_{7A}P_{score7A}+k_{7B}+P_{score 7B}+k_{7C}P_{score7C}+. . . k₇ₙP_{score7 n}]; or (2-34)

D_{X=mean[}k_{10A}P_{score10A}+k_{10B}P_{score10B}+k_{10C}P_{score10C}+. . . k₁₀ₙP_{score10 n}]; (2-35)

where D_{VII} and D_{X} are the diagnosis for the facial nerve (314) (CN VII) and the vagus nerve (320) (CN X), respectively; and the included scoring functions and their weightings are directly related to that specific cranial nerve (1042). Based upon the diagnostic score for each cranial nerve and the known geometry of the cranial nuclei in the brainstem, it may be possible to geometrically project the location and density of CWD vacuoles (1044) within the obex region (326).

Based upon empirical data, it can be determined which cranial nerves are first impacted by CWD and which are impacted in later stages. (It is anticipated that the facial nerve (314) is one of the early nerves affected.)

Application to Similar Diseases

While the present invention has been described as it applies to chronic wasting disease (CWD), this invention is also applicable to a number of other diseases which have similar physiological traits. Specifically, it is applicable to the following diseases which have cranial nerve involvement:

a) Mad-Cow Disease—a bovine transmissible, spongiform encephalopathy with a pathology similar to CWD;

b) Scrapie—a transmissible, spongiform encephalopathy with a pathology similar to CWD found in sheep;

c) Creutzfeldt-Jakob Disease—a rare transmissible, spongiform encephalopathy found in humans with a pathology similar to CWD;

d) West Nile Virus—a virus affecting birds, horses, and humans which may impact the cranial nerves;

e) Parkinson's Disease—a human neurological disorder accompanied with facial paralysis;

f) Bell's Palsy—a paralysis of the facial muscles; and

g) Horner's Syndrome—a set of characteristics which includes vasodilation of the inner external ear, sclera, and nose.

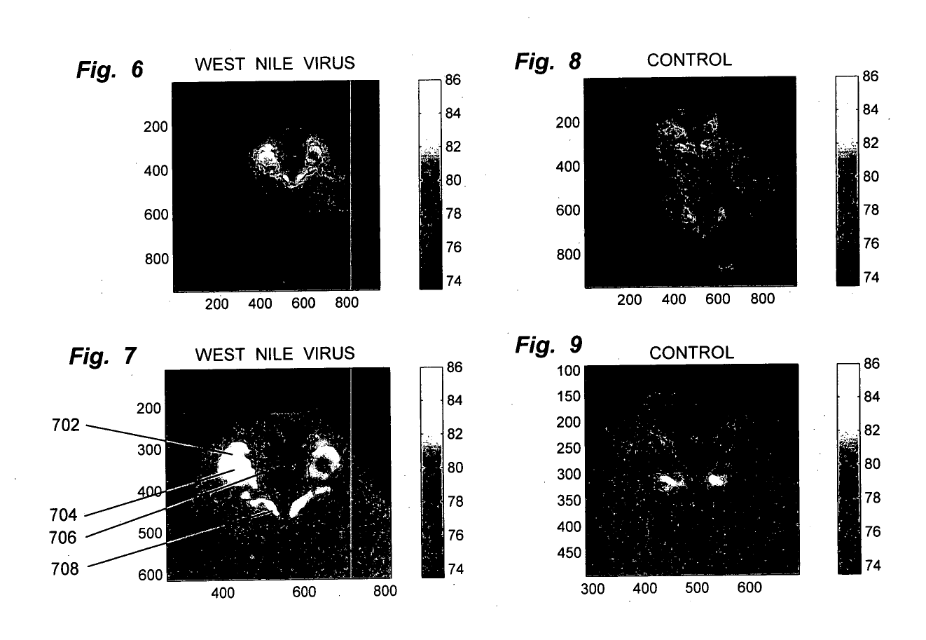

FIGS. 6, 7, 8 and 9 show thermal characteristics of West Nile Virus (WNV) in great horned owls that are similar to those discussed for CWD. WNV also impacts the facial nerve (314) (CN VII). As in CWD, the owls with WNV exhibit elevated temperatures of the sclera (704) and eyelids (702). Additionally, vasodilation of the sinuses (706) is evident. The beaks of WNV owls are open (708), possibly due to paralysis of the associated facial muscles. The control owl has none of the thermal characteristics evident in the diseased raptors.

### EMBODIMENTS OF THE INVENTION

This invention may be embodied in a number of forms. Key technical components common to many of the applications are described. Then specific applications are presented.

Technical Components

In typical applications of this invention an image is acquired. Thermal cameras are most useful since much of the valuable information is visible only in thermally sensitive images. However, visible spectrum cameras may be able to obtain images that provide limited data such as ear angles, shoulder droop, and salivation.

Thermal Imaging Technology.

In the past, thermal cameras were large and expensive. They typically provided an analog display with documentation only via film camera attachments. The thermal detectors required liquid nitrogen to obtain operating temperatures near absolute zero. Portability was limited due to the large and heavy battery packs. These cameras were expensive, typically costing several tens of thousands of dollars.

Recent solid state developments now provide hand-held, thermal imaging cameras that resemble an oversized, 35 mm film camera. They operate at room temperature without expensive cooling systems. An example of such a solid-state, uncooled, thermal imaging camera is the IR SnapShot® manufactured by Infrared Solutions, Inc., Plymouth, Minn. It is an imaging radiometer, an infrared camera that acquires a thermal image of a scene and can determine the temperature of any pixel within that scene. With the push of a button, a 120-element linear thermoelectric detector array scans across the focal plane of a germanium IR lens in approximately 1.6 seconds. Camera software stores a thermal image, 120 ×120 pixels, within the camera in flash memory cards. The camera can also download the images directly to a laptop or desktop computer for storage or post-processing. The calibrated thermal images may be displayed with numerous colormaps on either the color LCD display of the camera or in computer displays. The price of the IR SnapShot, thermal imaging camera is significantly less than that of the older cameras.

Radiometric IR cameras that operate at a video rate are soon to become available. These cameras will provide calibrated thermal images at the faster, video rate of 30 frames per second. Typically, the thermal images may be viewed in real time at the video rate with a freeze frame capability which stores or downloads the selected frames.

Thermal images from radiometric cameras, still or video, provide a volume of temperature information for analysis and processing. The data may be represented as a matrix of temperatures in which each element corresponds to a pixel in the thermal image. These pixels, in turn can be used to measure the temperature of anatomical features when the subject of the image is the test animal or patient. Image processing techniques may be applied to the temperature matrices as with any other matrix. Image resolution may be enhanced by applying image interpolation techniques such as one or two dimensional spline fits to the image data. Using custom MATLAB processing routines, the resolution of the thermal images may be enhanced from 120 ×120 pixels to 953×953 pixels. This increases the number of temperature points in an image from 14,400 points to 908,209 points.

Visible Spectrum Digital Cameras

The number of digital cameras which operate in the visible spectrum is increasing daily. A full discussion of the camera options is beyond the scope of this application. Digital still cameras now exist with resolution ranging from 2 megapixels to over 6 megapixels without external processing or interpolation. A number of images can be stored within the camera and downloaded to a laptop or desktop computer when convenient. These images may be processed via MATLAB routines or custom image processing routines to extract the desired features and measurements. Digital video cameras are also becoming available.

Image Processing

The thermal or visible spectrum images may be processed in a number of ways to extract the desired information.

One straightforward way to accomplish the desired processing is to download the images to a desktop or laptop computer running MATLAB software. MATLAB analysis software can be used to write the custom algorithms described herein. The hardware, software and user interfaces are convenient and available via MATLAB.

The image processing software, written in C++or an equivalent programming language, may reside directly within the imaging camera. Such resident programs may make analysis and output very fast and convenient.

Applications

The technology used to implement live-animal, CWD diagnostics with the present invention varies with test subject and cost. In general, thermal imaging systems provide the best analysis and diagnostic capability accompanied by higher equipment costs. Visible spectrum scopes and cameras offer lower cost systems and convenience, but provide a more limited analysis capability. Typical systems components and their applications are described in the following sections. While these sections are intended to describe the potential combinations of technology and applications, they are not meant to be all inclusive or limiting in scope.

Manual Scanning of Captured Animals

If deer or elk are captured or confined in a small chute, a thermal imaging system composed of an infrared camera, personal computer (PC), and custom analysis software may be used to diagnose the live animals under test. This equipment may be set up in a small room adjacent to the animal pens or temporarily set up on tripods in a field. Thermal images of sufficient resolution may be obtained from a distance of 8 to 12 feet. While still cameras are sufficient, thermal video monitoring with still-image capture provides even greater convenience in acquiring accurate images. The thermal images may be downloaded to a desktop or laptop PC for storage and analysis. A nearly instantaneous diagnosis may be obtained if the custom analysis software is resident in the PC. This analysis software implements the algorithms of this invention. An instantaneous, positive live diagnosis enables handlers to immediately isolate the animal. This avoids the inconvenience of having to recapture the animal at a later time. It also eliminates hours or weeks of herd contact with an infected animal, as would be common waiting for results from laboratory tests.

Manual Scanning of Commercial Herds.

Commercial herds of deer or elk may be manually scanned with a thermal imaging system as described above. This entails capturing or confining herd animals individually and then obtaining thermal images as previously described.

However, greater convenience for commercial ranchers is possible by adding a longer infrared lens capable of imaging the animals while they are roaming in the pens. This greater magnification, available for either still or video cameras, provides image acquisition at distances of 20 to 150 feet depending upon the specifications of the IR lens. Analysis follows, as described previously, after downloading the images to a PC containing the custom analysis software.

With this approach, live CWD diagnosis is transformed from a high-risk, capture event (necessary for tonsil biopsies or blood tests) to a remote photography session.

Automated Scanning of Commercial Herds.

The acquisition of images may be automated, for example by setting up position sensors and imaging equipment such that the animals take their own pictures by triggering the position sensors. The equipment and sensors may be strategically placed along chutes near feed troughs or water supplies. By conveniently locating a set of position sensors along a well-traveled path, a thermal image may be acquired at the opportune moment when the animal is properly positioned. Image analysis and diagnostics may be performed as previously described. Individual animals may be identified by placing unique thermal patterns on ear tags visible in the images. Such ear tags may use multiple, IR emissivities to create unique, identifiable patterns. The ear tags may also use an RF method of identification.

Surveying Wild Herds from the Ground

With the present invention live-animal, CWD test may be conveniently administered remotely to wild deer and elk. The thermal camera and PC may be made fully portable permitting live-animal CWD diagnosis from tree stands, moving vehicles, or on foot.

Culling Wild Herds from the Ground.

This invention is particularly suited for culling wild populations of deer and elk. When included as a modified rifle scope, this invention permits wildlife managers to site a live animal, determine if it is diseased, and immediately take the appropriate action. This application enables culling of only the diseased animals. Since diseased animals in the wild may only account for 1-6% of the population, this invention saves 94-99% of the deer population. In a CWD program targeting 25,000 deer, this invention eliminates the slaughter of 23,500 healthy animals (assuming 5% of the population is diseased). The cost of disposing of an additional 23,500 carcasses is also removed.

A system employing this invention with a lower-cost, visible spectrum camera may be suitable for this application. If diagnostic reliability is proven, the analysis of visible traits such as ear angle, head tilt and shoulder droop would be possible for a reduced cost. Miniaturization would also be an advantage of a visible spectrum system. Telephoto and zoom lenses are also commonly available.

Surveying Wild Herds from the Air

As has been discussed, the present invention permits remote, live diagnosis of CWD. The transformation from a laboratory test to a photography session provides even greater opportunities. With the appropriate thermal imaging camera, this remote monitoring can even be extended to live animal CWD diagnosis from an aircraft. This makes it possible to survey wild animal populations from the air. Though the infrared optics for aircraft distances are expensive, the use of the present invention for this unique monitoring application is unavailable from any other technology or laboratory test.

Research Applications

While a definitive diagnosis of CWD is the primary focus of the present invention, this invention also may be used to track the progress of the disease. Due to the convenience of this live test, it may be used daily or weekly to track the progress of CWD from initial exposure to severe clinical symptoms. The characteristics of CWD described herein may be grouped according to cranial nerve association as illustrated in equations (2-34) and (2-35). With such periodic data acquisition, the impact on each cranial nerve may be scored over time and plotted in multi-dimensional graphs. Such data can also be organized according to anatomical position of the cranial nerve nuclei in the brainstem. By transforming the degree of degradation of each cranial nerve function over time to that nerve's specific nuclei position near the pons, a 3D, time map of the vacuolization of the brainstem may be generated.

I claim:

1. A method of noninvasively and/or remotely testing a live animal for a transmissible spongiform encephalopathy (TSE) disease such as chronic wasting disease (CWD) or mad cow disease, comprising:
taking a thermal image of the live animal; and
processing the thermal image to determine the presence of a TSE disease such as chronic wasting disease or mad cow disease.

2. A method as recited in claim 1, wherein taking the thermal image includes taking the thermal image from a distance of 15 feet or less from the live animal;

3. A method as recited in claim 1, wherein taking the thermal image includes taking the thermal image from a distance of greater than 15 feet from the live animal;

4. A method as recited in claim 1, wherein taking the thermal image includes taking the thermal image using a thermal camera located on an airborne platform.

5. A method of noninvasively and/or remotely testing a live animal for a transmissible spongiform encephalopathy (TSE) disease such as chronic wasting disease (CWD) or mad cow disease, comprising:
taking a visible spectrum image of the live animal; and
processing visible spectrum image to determine the presence of a TSE disease such as chronic wasting disease or mad cow disease.

6. A method as recited in claim 5, wherein taking the visible spectrum image includes taking the visible spectrum image from a distance of 15 feet or less from the live animal.

7. A method as recited in claim 5, wherein taking the visible spectrum image includes taking the visible spectrum image from a distance of greater than 15 feet from the live animal;

8. A method as recited in claim 5, wherein taking the visible spectrum image includes taking the visible spectrum image using a visible spectrum camera located on an airborne platform.

9. A method of noninvasively and/or remotely testing a live human subject for a transmissible spongiform encephalopathy (TSE) disease such as Creutzfelt-Jakob disease or mad cow disease, comprising:
taking a thermal image of the live human subject; and
processing the thermal image to determine the presence of a TSE disease such as Creutzfelt-Jakob disease or mad cow disease.

10. A method as recited in claim 9, wherein taking the thermal image includes taking the thermal image from a distance of 15 feet or less from the live human subject;

11. A method as recited in claim 9, wherein taking the thermal image includes taking the thermal image from a distance of greater than 15 feet from the live human subject;

12. A method of noninvasively and/or remotely testing a live human subject for a transmissible spongiform encephalopathy (TSE) disease such as Creutzfelt-Jakob disease or mad cow disease, comprising:
taking a visible spectrum image of the live human subject; and
processing visible spectrum image to determine the presence of a TSE disease such as Creutzfelt-Jakob disease or mad cow disease.

13. A method as recited in claim 12, wherein taking the visible spectrum image includes taking the visible spectrum image from a distance of 15 feet or less from the live human subject.

14. A method as recited in claim 12, wherein taking the visible spectrum image includes taking the visible spectrum image from a distance of greater than 15 feet from the live human subject;

15. A method of noninvasively and/or remotely testing a live animal or live human for a disease that affects one or more cranial nerve(s), comprising
taking at least one of a thermal image and a visible spectrum image of the live animal or human; and
processing the at least one of a thermal image and the visible spectrum to determine the presence of the disease that affects cranial nerves.

16. A method recited in claim 15, wherein the disease is a transmissible spongiform encephalopathy disease (TSE) or a variant thereof.

17. A method recited in claim 15, wherein the disease is at least one of CWD, scrapie, mad cow disease, Creutzfelt-Jakob disease, West Nile virus, Bell's Palsy, Horner's Syndrome, and Parkinson's disease, or a variant thereof.

18. A method of tracking progress of a disease that affects cranial nerves in a live animal or human, comprising:
taking a first image set comprising a first thermal image and/or a first visible spectrum image of the live animal or human;
taking at least a second set comprising a second thermal image and/or a second visible spectrum image of the live animal or human;
comparing information from the second image set to information from the first image set and determining progress of the disease.

19. A method recited in claim 18, wherein the disease is a transmissible spongiform encephalopathy disease (TSE) or a variant thereof.

20. A method recited in claim 18, wherein the disease is at least one of CWD, scrapie, mad cow disease, Creutzfelt-Jakob disease, West Nile virus, Bell's Palsy, Horner's Syndrome, and Parkinson's disease, or a variant thereof.

21. A method as recited in claim 18, further comprising using the information from the first and second image sets to calculate a degradation score for individual cranial nerves.

22. A method as recited in claim 18, further comprising using the information from the first and second image sets to calculate a degradation score for grouped cranial nerves.

23. A method as recited in claim 18, further comprising tracking the vacuolization of the brainstem of the live animal or human by tracking the progress of the degradation of cranial nerve functions in conjunction with the 3D, anatomical positions of the cranial nerve nuclei in the brainstem.
